(19) United States
(12) Patent Application Publication
(10) Pub. No.: US 2003/0087021 A1
(43) Pub. Date: May 8, 2003

(54) Candy mix and method for preparing a hard candy

(76) Inventors: Robert W. Wood, Cranbury, NJ (US); Maureen E. Lennon, Tarzana, CA (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/236,134

(22) Filed: Sep. 6, 2002

Related U.S. Application Data
(60) Provisional application No. 60/318,753, filed on Sep. 12, 2001.

(51) Int. Cl. A23G 3/00

(52) U.S. Cl. 426/660

(57) ABSTRACT

A candy mix for preparing hard candies, in particular, is preferably in the form of a dry, free-flowing powder having a melting point of less than about 250° F. and comprises fructose, a food acid and flavor. A mix as defined is added to a molding cavity of a mold, preferably a stick is inserted into the molding cavity before or after the mix is added, the mold is closed, the contents of the mold are heated, the mold and its contents are cooled and the temperature of the contents are sensed directly or indirectly to assure safety before the mold is opened.

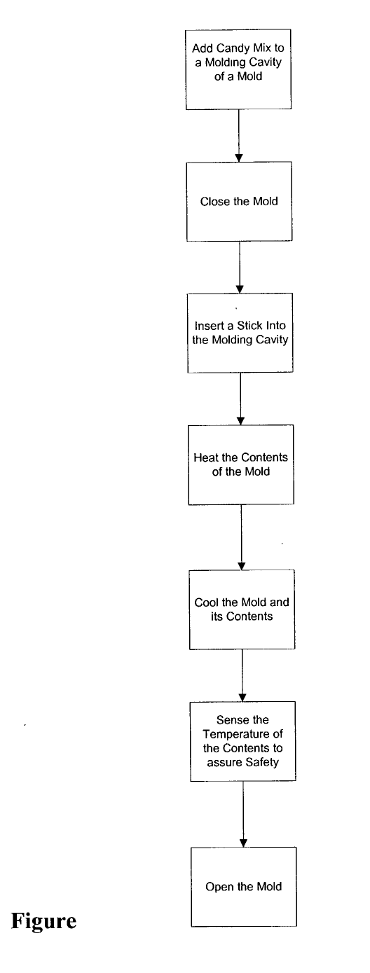

### PRIORITY APPLICATION

This application claims priority to U. S. Provisional Application 60/318,753, filed Sep. 12, 2001, by the inventors named herein.

### BACKGROUND OF THE INVENTION

The invention relates to candy mix, preferably dry, having the property of forming a candy melt at a low temperature to enable the safe, home preparation of hard candies.

Hard candies are favorites of many candy lovers. They provide a variety of flavors and are available in a number of forms that can create a level of interest. Children love to eat and enjoy them and are curious as to how they are made. Unfortunately, they are not easily prepared safely at home. Hot candy melts have such high temperatures and viscosities that any contact with the skin can cause serious bums. The hot candy melt tends to stick on the skin and cannot be cooled or washed off quickly enough to avoid severe trauma. Indeed, even most adult cooks tend to shy away from making hard candies due to the bum danger involved.

Typically hard candy is made from sugar, color, flavor, and acidulant. The ingredients are heated sufficiently to form a melt which, when cooled, forms a hard glassy candy. The sugar typically will be a mix of sucrose and a small amount, e.g., less than 10%, of glucose and/or fructose (monosaccharides) to provide a sugar glass. The glucose or fructose can be added overtly or by partial inversion of the sucrose. The ingredients are typically blended with sufficient water to assure complete solubility and heated to make a candy melt, with hard candies requiring temperatures of in excess of 300° F.

Sugars other than sucrose have been attempted as the principal sugar but they tend to have adverse effects on the final candy and there remain good reasons why they are not widely employed. For example, fructose tends to be highly hygroscopic.

While many children are fascinated by the art of cooking and toys have been designed to make various food products from mixes, there is nothing available for providing children—or adults for that matter—with a formulation and method for safely preparing hard candy at home.

There remains a need for a candy mix, preferably dry, exhibiting the property of forming a candy melt at a low temperature to enable the safe, home preparation of hard candies.

### BRIEF DESCRIPTION OF THE DRAWINGS

The invention will be better understood and its advantages will become more apparent from the following description, especially when read in light of the accompanying drawing, wherein:

The FIGURE is a schematic drawing illustrating a process sequence for forming a hard candy utilizing a candy mix according to the invention.

### SUMMARY OF THE INVENTION

It is an object of the invention to provide a candy mix exhibiting the property of forming a candy melt at a low temperature to enable the safe, home preparation of hard candies.

It is another object of the invention to provide a candy mix, preferably dry, exhibiting the property of forming a candy melt at a low temperature to enable the safe, home preparation of hard candies.

It is another object of the invention to provide a process for preparing hard candies from a candy mix exhibiting the property of forming a candy melt at a low temperature to enable the safe, home preparation of hard candies.

It is another object of the invention to provide a process for preparing lollipops comprised of hard candies from a candy mix exhibiting the property of forming a candy melt at a low temperature to enable the safe, home preparation.

These and other objects are accomplished by the invention, which provides both a hard candy mix and a process for employing it to prepare hard candies. The candy mix preferably is in the form of a dry, free-flowing powder having a melting point of less than about 250° F. and comprises fructose, a food acid and flavor. According to the method of the invention a mix as defined is added to a molding cavity of a mold, preferably a stick is inserted into the molding cavity before or after the mix is added, the mold is closed, the contents of the mold are heated, the mold and its contents are cooled and the temperature of the contents are sensed directly or indirectly to assure safety before the mold is opened.

The mix and process have a number of preferred aspects, many of which are described below and shown in the attached drawing.

### DETAILED DESCRIPTION OF THE INVENTION

While the invention has broader utility, the following description will detail preferred forms wherein a hard candy is prepared by heating and cooling in a molding process. It will be understood that the invention applies with equal weight to candies made in different types of processes, such as with depositors or the like.

The candies and candy mixes of the invention require a sugar that is suitable to provide a candy melt having a low melt temperature, e.g., less than normally encountered for hard candies and preferably below 250° F., e.g., from 220° to 240° F. Fructose is the sugar of choice and will preferably comprise at least 75%, and preferably at least 90%, of the dry mix. It is preferably added in dry crystalline form to minimize the need for boiling off water.

The mix requires an acid component, which is preferably citric acid, but can comprise any of the suitable food acidulents, e.g., adipic acid, citric acid, fumaric acid, lactic acid, malic acid (e.g., dl malic), tartaric acid, and mixtures of at least two of these. In some cases, fumaric acid will be employed due to its relatively low hygroscopicity. The acid will typically be added in an amount of less than 5% of the mix, e.g., from 2 to 4%. It may be desirable to add one or more buffering salts compatible with the acid and other ingredients. Suitable buffering salts can include one or more members selected from the group consisting of the alkaline earth and/or alkali metal salts of calcium, sodium and potassium salts of the listed food acids. Among the specific useful weak acid salts are sodium citrate, potassium citrate, disodium phosphate, dipostassium phosphate, monocalcium phosphate, tricalcium phosphate, and mixtures of at least two of these. Tricalcium phosphate and others can also improve flow properties of the dry candy mix of the invention.

The flavor component of the candies and candy mixes of the present invention can be either a natural or artificial flavor selected from fruit flavors, botanical flavors and mixtures thereof. Fruit flavors refers to those flavors derived from the edible reproductive part of the seed plant, especially one having a sweet pulp associated with the seed, for example, apples, oranges, lemon, limes, etc. Also included within the term fruit flavor are synthetically prepared flavors made to simulate fruit flavors derived from natural sources. Particularly preferred fruit flavors are the citrus flavors including orange, lemon, lime and grapefruit flavors. A variety of other fruit flavors can be used such as apple, grape, cherry, pineapple, coconut and the like. These fruit flavors can be derived from natural sources such as fruit juices and flavor oils or synthetically prepared.

As used herein, the term botanical flavor refers to flavors derived from parts of the plant other than the fruit. As such, botanical flavors can include those flavors derived from nuts, bark, roots and leaves. Also included within this term are synthetically prepared flavors made to simulate botanical flavors derived from natural sources. Examples of botanical flavors include cola flavors, tea flavors, coffee and the like. These botanical flavors can be derived from natural sources such as essential oils and extracts or be synthetically prepared. Coffee, black tea, and herbal tea extracts can be used as the flavorant herein. The flavor component can comprise a single flavor or blended flavors.

The particular amount of the flavor component effective for imparting flavor characteristics to the candies and candy mixes of the present invention will depend upon the flavor, the flavor impression and formula flavor component. For example, the flavor component can comprise at least 0.05% by weight of the candy composition and typically from 0.1% to about 2% by weight of the candy.

Desirably, the candy mix will also include a color, which can be utilized in any of the various forms available for food colors. The amount used will be dictated by the color desired and the intensity of the color.

Other minor ingredients can also be employed. For example, in some cases it is advantageous to add a small amount, e.g., less than 2%, of a polyhydric alcohol such as glycerol, propylene glycol, sorbitol, mannitol or the like. In addition, various hydrophilic colloids can be employed with good effect. Among these are the natural and synthetic gums and the like, including gum arabic, gum acacia, guar gum, gum tragacanth, xanthan gum, propylene glycol alginate, carboxymethyl cellulose, and mixtures of these.

The candy mix of the invention will preferably be a dry, free-flowing powder or granular material. In other words, it will preferably be pourable from its packaging container without the need for undue mixing. To achieve this desirable texture, it is preferred to use little or no liquid component. In some cases small amounts of liquid such as water, glycerol or propylene glycol can aid in processing. However, the ingredients are typically and preferably mixed dry in a V-blender or like mixer under controlled humidity conditions. Preferably the ambient air should be maintained below 50% relative humidity and preferably 30% or less.

Following mixing the dry mix is preferably immediately packaged in sealed pouches or other containers. Two effective types of packaging are those known in the art as poly-foil packs and foil-covered tubs of the type used to package various beverage mixes. The dry mix can be added in amounts sufficient to form one or a desired number of candies. While not preferred, the mix can be packaged like toothpaste in the form of a paste—a form that might be required for formulations having a significant liquid component.

Candies are prepared with the mix of the invention by placing a desired amount of the mix, e.g., several grams, or a teaspoon full, in a molding cavity of a closeable mold having means for heating and cooling the contents. Preferably, the molding apparatus will also have means for suitably holding a stick for securing it in the molded candy. Thus, as can be seen in the FIGURE, dry mix is added to a molding cavity of a mold, preferably a stick is inserted into the molding cavity before or after the mix is added, the mold is closed, the contents of the mold are heated, the mold and its contents are cooled and the temperature of the contents are sensed directly or indirectly to assure safety before the mold is opened.

The following Examples are provided to further illustrate and explain a preferred form of the invention and is not to be taken as limiting in any regard. Unless otherwise indicated, all parts and percentages are by weight.

### EXAMPLE 1

This example presents several embodiments of the invention wherein a number of formulations, listed below are blended and then heated to form a low-temperature candy melt and then molded and cooled to form a continuous hard candy portion.

| Ingredient | Formula 1 | Formula 2 | Formula 3 | Formula 4 | Formula 5 |
|---|---|---|---|---|---|
| Fructose | 100 | 100 | 100 | 100 | 100 |
| Citric Acid | 3.00 | 4.00 | 2.50 | 2.50 | 2.50 |
| Color | 0.02 | 0.02 | 0.02 | 0.02 | 0.02 |
| Flavor | 0.2 | 0.2 | 0.2 | 0.2 | 0.2 |
| Propylene | 1.00 | 0 | 0 | 0.50 | 0 |
| Glycol | | | | | |
| Glycerin | 0 | 0 | 1.00 | 0 | 0 |
| Water | | | | | 0.50 |
| Total | 104.22 | 104.22 | 103.72 | 103.22 | 103.22 |

For each formula, the dry ingredients are blended. Then, any liquid is added and mixed. The result in all cases is a relatively dry, crumbly mix. The mix is then heated at 250° F. for 30 minutes or until all ingredients are melted. The resulting candy melt is then cooled in a refrigerator. All formulations met the objective of providing a dry mix that melted at low temperature and could be cooled to form a hard candy.

The above description is intended to enable the person skilled in the art to practice the invention. It is not intended to detail all of the possible modifications and variations which will become apparent to the skilled worker upon reading the description. It is intended, however, that all such modifications and variations be included within the scope of the invention which is seen in the above description and otherwise defined by the following claims. The claims are meant to cover the indicated elements and steps in any arrangement or sequence which is effective to meet the objectives intended for the invention, unless the context specifically indicates the contrary.

1. A candy mix for preparing hard candies comprises: a mix having a melting point of less than about 250° F. comprising fructose, a food acid and flavor.

2. A candy mix according to claim 1, which comprises a dry, free-flowing powder.

3. A candy mix according to claim 1, which comprises at least 75% fructose.

4. A candy mix according to claim 1, which comprises at least 90% fructose.

5. A candy mix according to claim 1 wherein the candy is a hard candy.

6. A candy mix according to claim 1, which further comprises a hydrophilic colloid.

7. A method for preparing hard candies comprising adding a mix as described in any of claims 1-6 to a molding cavity of a mold, closing the mold, heating the contents of the mold, cooling the mold and its contents, sensing the temperature of the contents to assure safety and opening the mold.

8. A process according to claim 7 including the further step of inserting a stick into the molding cavity.

9. A process according to claim 7 wherein the mix comprises a dry, free-flowing powder.

10. A process according to claim 7 wherein the mix comprises at least 75% fructose.

11. A process according to claim 7 wherein the mix comprises at least 90% fructose.

12. A process according to claim 7 wherein the candy is a hard candy.

13. A process according to claim 7 wherein the mix further comprises a hydrophilic colloid.
